(19) United States
(12) Patent Application Publication
(10) Pub. No.: US 2013/0145685 A1
(43) Pub. Date: Jun. 13, 2013

(54) DEVICE AND METHOD FOR SEPARATING A SOLID MATTER-CONTAINING,LIQUID AND PUMPABLE TAR SUSPENSION AND USE OF THE SEPARATED SOLID MATTER FOR PRODUCING COKE

(71) Applicant: Holger Thielert, Dortmund (DE)

(72) Inventor: Holger Thielert, Dortmund (DE)

(73) Assignee: THYSSENKRUPP UHDE GMBH, Dortmund (DE)

(21) Appl. No.: 13/520,480

(22) PCT Filed: Dec. 21, 2010
(86) PCT No.: PCT/EP2010/007840

§ 371 Date: Oct. 1, 2012

(30) Foreign Application Priority Data
Jan. 6, 2010 (DE) 10 2010 004 082.7

(51) Int. Cl. B01D 21/26

(52) U.S. Cl. CPC B01D 21/262
USPC 44/607; 494/43; 494/37

(57) ABSTRACT

A device for separating a solid matter-containing, liquid and pumpable tar suspension from a coking reaction with direct use of the separated solid matter contained therein. The device consists of a centrifuge, which is arranged in the upper inner region of a carbon-storing container, and the centrifuge is equipped with a feed nozzle for solid matter-containing, liquid tar and with a discharge nozzle for liquid tar centrifugate. In the lower part, the centrifuge is equipped with an outlet for the solid matter contained in the tar, whereby the tar-containing solid matter obtained from the tar suspension does not have to be delivered or transported. Also disclosed is a method is for separating a solid matter-containing, liquid and pumpable tar suspension with delivery-free use of the separated solid matter contained therein using the device and to the use of the coal mixed with the solid matter.

The invention relates to a contrivance for fractionating a solids-containing, liquid and pumpable tar suspension and for utilising the isolated solid that was contained therein without the need for it to be conveyed, said contrivance being located in the upper part of a coal storage container and said contrivance consisting of a centrifuge that fractionates a solids-containing, pumpable tar or a solids-containing, pumpable tar suspension into a liquid phase and the solids contained therein so that the solid can be placed directly onto or into the stored coal without subsequent conveyance so that only a tar suspension needs to be pumped or transported and not any of the isolated solid. The invention also relates to a process for fractionating a solids-containing, liquid and pumpable tar suspension and for storing the solid obtained with coal as well as application of the process to produce coke from coal blended with the solid.

The coking of coal to produce coke often creates a viscous solids-laden tar suspension that needs to be fractionated for further processing. Due to the consistency of the tar, fractionation of the solid is usually carried out using a centrifuge, but this entails the problem that the solid obtained needs to be conveyed or transported following fractionation. This involves substantial expense.

Processes for the fractionation of tar suspensions from coking processes are known. JP 07188671 A describes a process for fractionating tar suspensions and utilising the solid obtained, said process involving dilution of a tar suspension that is obtained from a coking process, the dilution obtained being centrifuged, and the solid obtained as well as the tar that has been freed of the solid being further processed. GB 789709 A describes a process for fractionating liquid and solid components from hard coal tar, said process involving the production of an aqueous dispersion with the aid of suitable additives and said dispersion being fractionated by a centrifuge into a supernatant liquid phase and the solids contained therein.

These processes have the disadvantage that the sticky tar-containing solids obtained need to be conveyed or transported. A common process for further use of the solid is, for example, to blend it with feedstock coal and store both together. However, due to the consistency of the tar-containing solid, the devices used for conveyance, such as screw or belt conveyors, are susceptible to failures, largely ineffective or require the use of additional costly devices, such as high-pressure double-walled delivery lines.

Therefore, the objective is to provide a process for improving or avoiding the difficulties encountered in conveying the solid recovered from the fractionation of a solids-containing, liquid and pumpable tar suspension and for utilising the solid without the need for it to be conveyed, the intention being to add said solid obtained from the fractionation to the coal stock.

The invention achieves this objective by means of a contrivance consisting of a centrifuge located in the upper inside section of a coal storage container, said centrifuge being equipped with a feed nozzle for solids-containing liquid tar, a discharge nozzle for liquid tar centrifugate and in the bottom part an outlet for the solid contained in the tar. After centrifuging, the solids obtained from the centrifugation preferably fall by gravitational force into the coal storage container where the coal is being stored.

This obviates the need for the solid to be conveyed from the centrifuge or a downstream container to the coal storage container. The solids from the centrifuging process fall directly into the coal in the coal storage container. The centrifuged liquid tar is discharged from the centrifuge in the container via a line with a pump. This liquid tar can be returned to a feed tank or further exploited. The solids-containing, liquid and pumpable tar suspension can be diluted or blended with additives prior to centrifugation. The coal storage container may, for example, be a coal storage silo.

What is claimed in particular is a contrivance for fractionating a solids-containing, liquid and pumpable tar suspension from a coking reaction and for using the isolated solid that was contained therein without the need for it to be conveyed, characterised in that
said contrivance consists of a centrifuge located in the upper inside section of a coal storage container, and
the centrifuge is equipped with a feed nozzle for solids-containing, liquid tar and having a discharge nozzle for liquid tar centrifugate, and
the centrifuge is equipped with an outlet at the bottom for the solid contained in the tar.

What is also claimed is a process for fractionating a solids-containing, liquid and pumpable tar suspension from a coking reaction and utilising the isolated solid that was contained therein without the need for it to be conveyed by using the contrivance according to the invention. Said process is characterised in that a liquid, solids-containing and pumpable tar suspension is pumped into a centrifuge located in the upper section of a coal storage container, said centrifuge fractionating the tar suspension into a liquid tar centrifugate and a solid, and the solid is placed onto or into the coal, which is located in the coal container, without further conveyance or transport.

The solid which is obtained from the centrifugation and placed on the coal is preferably stored with the coal. Settling normally allows the solid obtained from the centrifugation to be stored with the coal in the coal storage container or the coal can even be mixed with the solid obtained from the centrifugation using suitable devices. Preferably, the solids-containing, liquid and pumpable tar suspension used for centrifugation originates from a process for the production of coke from coal.

What is also claimed is the use of a coal that contains a solid which is obtained by fractionating a solids-containing, liquid and pumpable tar suspension using a centrifuge in the upper inside section of a coal storage solid. Said coal can be used in particular for coking and for the production of coke.

The invention has the advantage that no cost-intensive pumping is required to convey the solid from the centrifugation of a solids-containing, liquid and pumpable tar suspension. The solid goes directly from the centrifuge onto the stored coal. It is only solids-containing, pumpable tar suspension or liquid tar that needs to be pumped. A considerable amount of energy or equipment is thus saved.

The configuration of a process for the coking of coal according to the invention is explained in greater detail by means of two drawings. The first drawing shows a prior-art device and the second shows a contrivance according to the invention. The process according to the invention is not limited to this configuration.

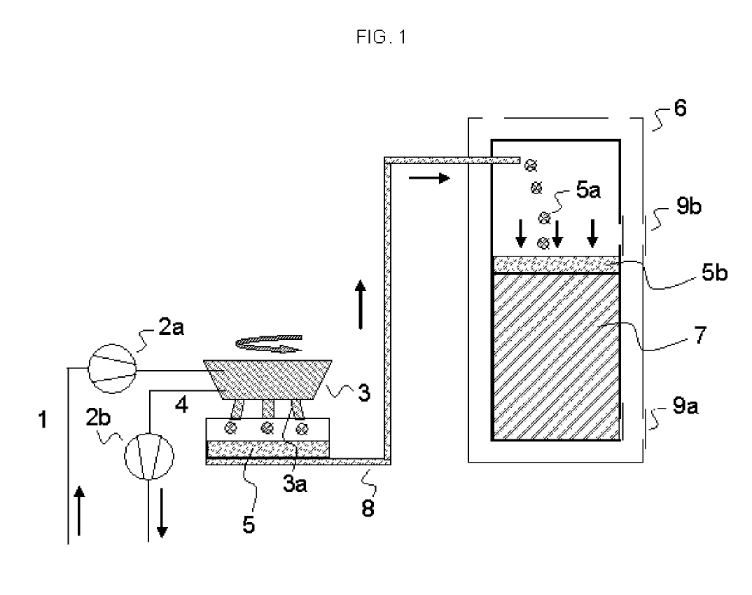

FIG. 1 shows a device according to the prior art. The liquid, solids-containing and pumpable tar suspension (1) is pumped to a centrifuge (3) by a pump (2a), where the supernatant liquid tar (4), which is pumped by a pump (2b) for further use, and the isolated solid (5) previously contained therein are obtained. Said solid (5) is put in a container (6) for storing coal (7). The transported solid from the tar (5a) is passed into the container (6) via a conveyor belt (8) or a screw conveyor. The solid from the tar (5b) is stored on the coal (7). The coal (7) can be removed from the container (6) via a suitable opening (9a) or topped up via another opening (9b).

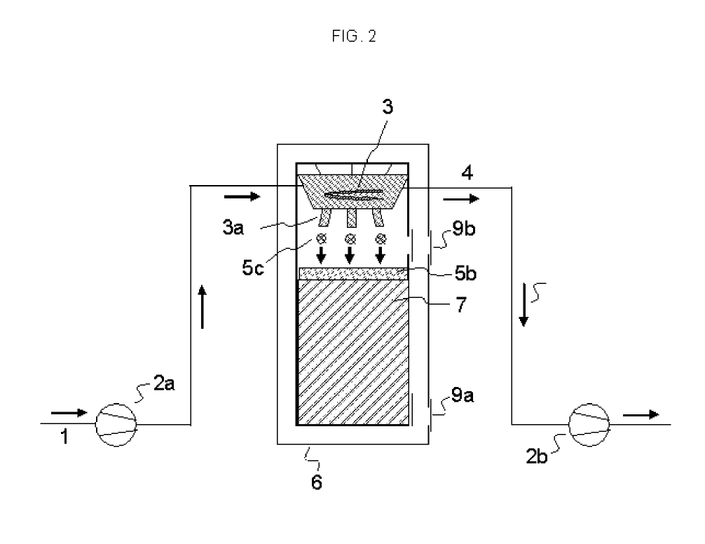

FIG. 2 shows a contrivance according to the invention. The liquid, solids-containing and pumpable tar suspension (1) is pumped to a centrifuge (3) by a pump (2a). According to the invention, the centrifuge (3) is located in the upper inside section of the container (6) for storing coal (7). In the centrifuge (3) the tar suspension is fractionated into supernatant liquid tar (4) and the solid (5) contained in the tar suspension. Said solid falls out of the openings (3a) in the centrifuge (3) onto the coal (7) by gravitational force (5b) and is stored there (5c). The liquid tar (4) is pumped out via a pump (2b). The coal (7) can be removed from the container (6) via a suitable opening (9a) or topped up via another opening (9b).

### LIST OF REFERENCE NUMBERS AND DESIGNATIONS

1 Liquid, solids-containing and pumpable tar suspension
2a Pump (for liquid, solids-containing and pumpable tar suspension)
2b Pump (for liquid tar)
3 Centrifuge
3a Centrifuge openings
4 Liquid tar or tar centrifugate
5 Isolated solid
5a Transported solid
5b Solid stored on coal
5c Solid falling out of the centrifuge
6 Container
7 Coal
8 Conveyor belt
9a Opening for removing coal
9b Opening for topping up coal

1. An apparatus for fractionating a solids-containing, liquid and pumpable tar suspension and subsequently utilizing the isolated solid that was contained therein and which falls by gravitational force into the coal storage container, wherein
said apparatus consists of a centrifuge located in the inside section of a coal storage container above the coal stock, and
the centrifuge is equipped with a feed nozzle for solids-containing liquid tar and having a discharge nozzle for liquid tar centrifugate, and
the centrifuge is equipped with an outlet at the bottom for the solid contained in the tar.

2. A process for fractionating a solids-containing, liquid and pumpable tar suspension and utlizing the solid that was contained therein after it has fallen into the coal storage container by gravitational force, wherein
a liquid, solids-containing and pumpable tar suspension is pumped into a centrifuge located in the internal space of a coal storage container above the coal stock, and
the centrifuge fractionates the tar suspension into a liquid tar centrifugate and a solid, and
the solid falls by gravitational force into the coal storage container, and is placed onto or into the coal, which is located in the coal container, without the need for further conveyance or transport.

3. The process for fractionating a solids-containing, liquid and pumpable tar suspension and utlizing the solid that was contained therein after it has fallen into the coal storage container by gravitational force according to claim 2, wherein the solids-containing, liquid and pumpable tar suspension originates from a process for the production of coke from coal.

4. The process for fractionating a solids-containing, liquid and pumpable tar suspension and using the solid that was contained therein after it has fallen into the coal storage container by gravitational force according to claim 2, wherein the solid which is obtained by centrifugation and placed on the coal falls by gravitational force into the coal storage container, and is stored with the coal.

5. A method of coking or production of coke using a coal containing solid from the fractionation of a solids-containing, liquid and pumpable tar suspension, the solid obtained by a process according to claim 2, the process further comprising:
blending the coal with solid material or tar centrifugate obtained from the centrifuge.

6. The process for fractionating a solids-containing, liquid and pumpable tar suspension and using the solid that was contained therein after it has fallen into the coal storage container by gravitational force according to claim 3, wherein the solid which is obtained by centrifugation and placed on the coal falls by gravitational force into the coal storage container, and is stored with the coal.

7. A method of coking or production of coke using a coal containing solid from the fractionation of a solids-containing, liquid and pumpable tar suspension, the solid obtained by a process according to claim 3, the process further comprising:
blending the coal with solid material or tar centrifugate obtained from the centrifuge.

8. A method of coking or production of coke using a coal containing solid from the fractionation of a solids-containing, liquid and pumpable tar suspension, the solid obtained by a process according to claim 4, the process further comprising:
blending the coal with solid material or tar centrifugate obtained from the centrifuge.
